(19) United States
(12) Patent Application Publication
(10) Pub. No.: US 2015/0216296 A1
(43) Pub. Date: Aug. 6, 2015

(54) VERTICAL HEIGHT WORK SURFACE ADJUSTMENT APPARATUS

(71) Applicant: QUEST ENG LLC, Grand Rapids, MI (US)

(72) Inventor: Terry Mitchell, Grand Rapids, MI (US)

(73) Assignee: QUEST ENG LLC, Grand Rapids, MI (US)

(21) Appl. No.: 14/614,874

(22) Filed: Feb. 5, 2015

Related U.S. Application Data
(60) Provisional application No. 61/965,699, filed on Feb. 5, 2014.

(51) Int. Cl. A47B 9/00; B62B 3/02; A47B 5/00; A47B 9/20

(52) U.S. Cl. CPC A47B 9/00; A47B 9/20; B62B 3/02; A47B 5/00

(57) ABSTRACT

A work surface height adjustment apparatus having a work surface platform and a scissors assembly mounted to a platform The scissors assembly has horizontal cross members, a scissors linkage mounted to the horizontal cross members, a control link mounted to the scissors linkage and a horizontal cross member. When extended, the scissors linkage creates two identical and opposing isosceles triangles.

### RELATED APPLICATIONS

This is a utility application claiming benefit and priority from U.S. Provisional Application No. 61/965,699, filed Feb. 5, 7014.

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISC APPENDIX

None.

### BACKGROUND OF THE INVENTION

1. Field of Invention

2. Description of the Prior Art

The drawing shown in FIG. 1 shows a prior art common height adjustable table. Telescoping legs provide 18″ to 20″ height adjustment for the table and a horizontal member connects and synchronizes the movement of the two legs. The telescoping leg design is expensive, restricts the design appearance of the table legs, and cannot be easily reduced in size for wall or office panel attachment.

Typically a non-adjustable work surface in an open office work space is attached directly to the panel without support legs. This keeps the knee space under the surface open for easy user leg movement, easier floor cleaning (because there are no table legs), and a cleaner, uncluttered looking work space. The problem is changing the work surface height requires manually removing and reinstalling the surface at a different height.

The drawing shown in FIG. 2 shows how freestanding height adjustable tables are currently used in a typical open office work space. This is an expensive solution to the problem and violates many advantages offered by panel created office spaces. A freestanding table is used because no one has invented a height adjustment device small enough to attach to a panel.

### SUMMARY OF THE INVENTION

The present invention addresses the ergonomic need to easily adjust the height of work a surface from a sit-down to stand-up position to promote blood circulation. Also people are different sizes so there is a need to adjust the work surface height between different people. Work surfaces are defined as a freestanding table, wall mounted work surface, work surface attached to an office panel, small horizontal surfaces like shelving or any horizontal surface that must remain level during and after the height is adjusted.

The ideal height work surface height range is 27″ for a low sit-down position and 47″ for stand-up position which is a 20″ adjustment range. Designing a telescoping leg mechanism to meet this adjustment range is difficult and requires using every inch of space inside the telescoping tubes. Adapting this mechanical concept to panel mounted surfaces results in a telescoping leg almost 27″ in height, which is why freestanding adjustable tables are used.

An ironing board is probably the simplest and most recognizable type of a work surface height adjustment mechanism. It contains a scissor mechanism to adjust the surface height from an almost fiat position to a stand-up position. It works by attaching a horizontal surface to one scissor link with a pivot and the other scissors link with a combination pivot/slider. The fixed pivot holds the surface in position and the combination slideripiv ot maintains the surface connection but allows the surface to Cantilever beyond the center line of the scissors. A ratchet type adjustment inside the slider locks the surface at different heights. If both links are the same length and the pivot connecting the links is at the center of each link, then the work surface is always parallel to the floor.

The advantages of a scissor mechanism are that only two simple parts are required, the tallest height is only limited by the length of the scissor link, and linkage folds into a flat compact package.

The problems with the ironing board type scissor linkage are the uneven cantilevered surface creates stability problems and the surface to scissor linkage relationship is not aesthetically acceptable, because it looks more like an ironing board than office furniture.

A work surface height adjustment apparatus having a work surface platform and a scissors assembly mounted to a platform. The scissors assembly has horizontal cross members, a scissors linkage mounted to the horizontal cross members, a control link mounted to the scissors linkage and a horizontal cross member. When extended, the scissors linkage creates two identical and opposing isosceles triangles.

It is an object of the invention to provide a simply constructed height adjustable work surface.

It is another object of the invention to provide a height adjustable work table.

It is yet another object of the invention to provide a height adjustable wall mounted assembly.

These and other objects, advantages, and novel features of the present invention will become apparent when considered with the teachings contained in the detailed disclosure along with the accompanying drawings.

### BRIEF DESCRIPTION OF THE DRAWINGS

The present invention will be described with reference to the appended Figures, in which:

FIG. 1 is a perspective view of an elevatable prior art table;

FIG. 2 is another perspective view of another elevatable prior art table;

FIG. 3 is schematic view of a scissors mechanism;

FIG. 4 is a perspective view of an elevatable table using a scissors mechanism of FIG. 3;

FIG. 5 is a schematic view of the improved inventive scissors linkage used with a height adjustable platform;

FIG. 6 is a front elevational view of a height adjustable table using the present invention;

FIG. 7 is a lowered compressed view of the table shown in FIG. 6;

FIG. 8 is an expanded view of a table according to the present invention;

FIG. 9 is a schematic view of a compressed table shown in FIG. 8;

FIG. 10 is a side elevational view of an inventive table with a single scissors linkage;

FIG. 11 is a side elevational view of an inventive table with a double scissors linkage;

FIG. 12 is a front elevation schematic view of a wall mounted platform;

FIG. 13 is the wall mounted platform of FIG. 12 in an extended position;

FIG. 14 is a side elevational view of the wall mounted embodiment shown in FIGS. 12 and 13;

FIG. 15 is a front elevational view of a rigid frame wall mounted embodiment;

FIG. 16 is a view of the wall mounted embodiment of FIG. 15 with a work surface support;

FIG. 17 is an elevational view of the rigid frame shown in FIG. 15 with cover;

FIG. 18 is an elevational view of the rigid frame shown in FIG. 15 with a scissors linkage;

FIG. 19 is a top sectional schematic view of the horizontal work surface rail;

FIG. 20 is a side elevational view of the inventive table with wall mount shown in FIG. 19;

FIG. 21 is a wall mount embodiment of the extendable table with an extension spring adding energy to lift the work surface;

FIG. 22 is a wall mount embodiment of the extendable table with a gas spring positioned between the two links of the scissor linkage to exert a force to lift the work surface;

FIG. 23 is a will mount embodiment with gas spring positioned between the lower horizontal bar and scissor linkage to exert a force to lift the work surface;

FIG. 24 is a wall mount embodiment with combination gas spring and electric motor positioned between the lower horizontal bar and scissor linkage to exert a force to fill the work surface;

FIG. 25 is an extendable table and work surface using telescoping tubes;

FIG. 26 is the table of FIG. 25 in telescoped position;

FIG. 27 is a table where the work surface height adjustment distance exceeds the apparatus width;

FIG. 28 is the table of FIG. 27 with the work surface height adjustment extended;

FIG. 29 is a side elevational view of the table of FIG. 28;

FIG. 30 is a front elevational view of a mobile cart using the height adjustment work surface; and

FIG. 31 is a side elevation view of FIG. 30.

### DESCRIPTION OF THE INVENTION

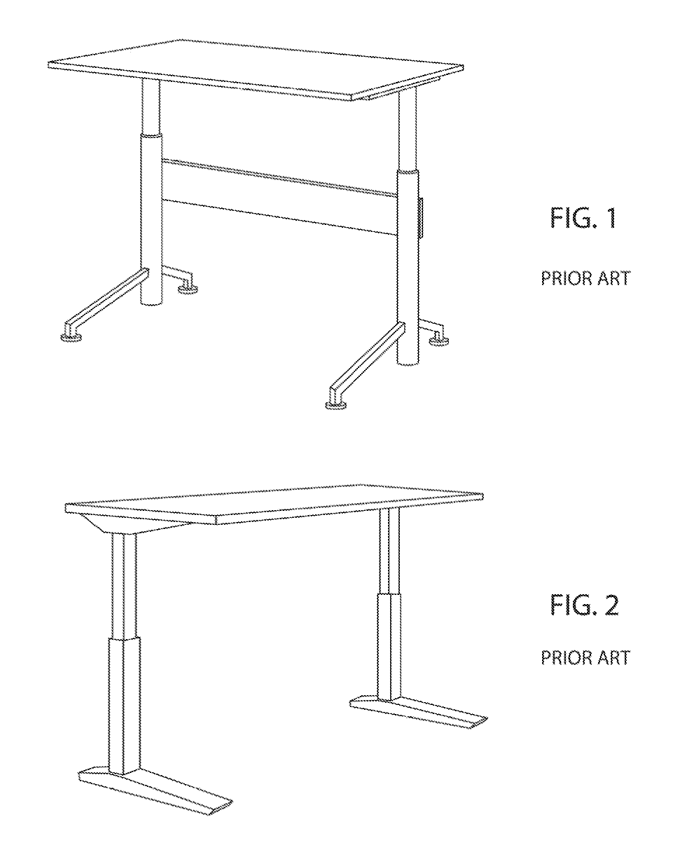

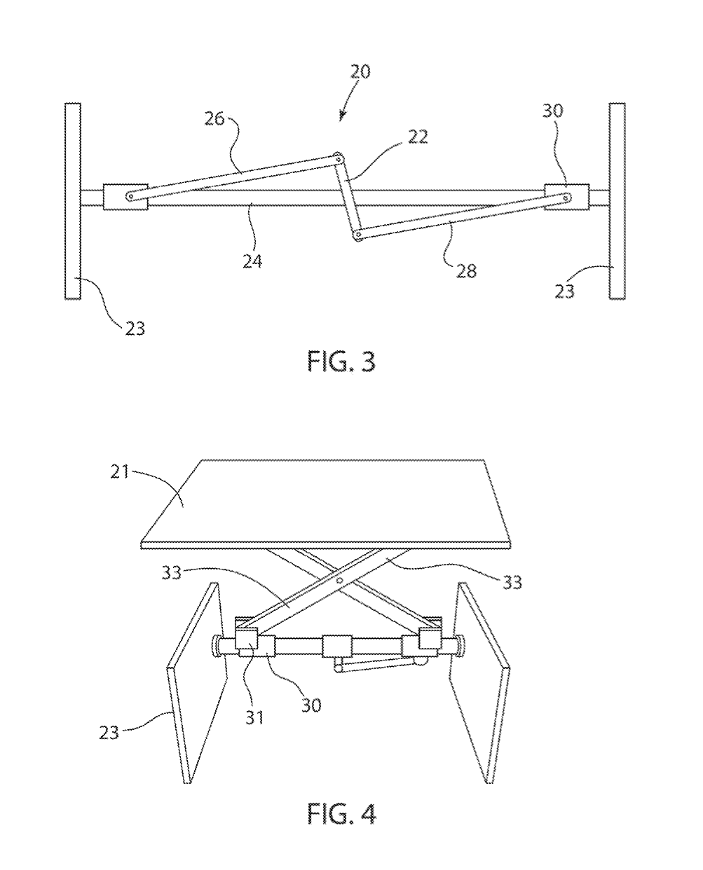

The present invention is directed towards a height adjustable work surface apparatus and the preferred embodiment and best mode of the invention is shown in FIGS. 3-5. The prior art is shown in FIGS. 1 and 2.

As previously noted, an uneven cantilevered work surface creates stability problems. The offset surface problem resulting in instability can be solved by creating a scissors linkage 20 that synchronizes the scissor movement to the top surface of the work member. This is shown in FIGS. 3 and 4 which have both the top work member 21 and legs 23 synchronized. FIG. 3 shows a center link 22 that pivots about the center of the horizontal bar 24 connecting the two legs 23. Push-Pull links 26 and 28 are attached with pivots between the center link 22 and the sliders 30. The two vertical scissor links 33 and 33a (not shown in FIG. 3) are attached to brackets 31 mounted on the two sliders 30.

This push-pull linkage of links 26 and 28, center link 22 and sliders 30 synchronizes the scissor movement to the legs 23 and/or top and keeps scissor linkage centered to the top and legs.

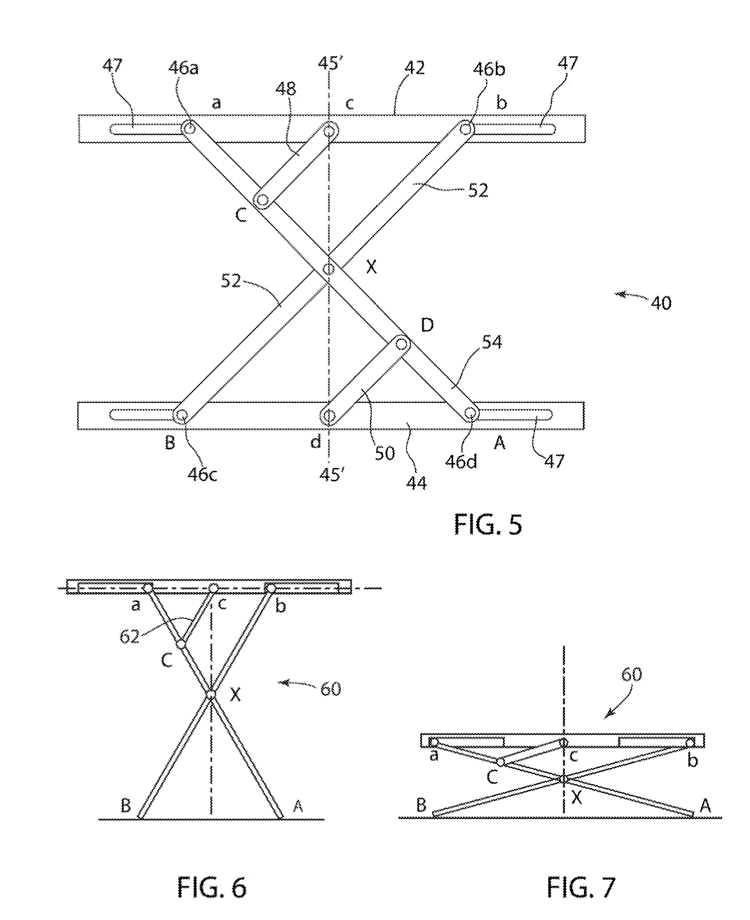

The preferred embodiment is a scissor linkage apparatus 40 shown in FIG. 5. The apparatus 40 comprises linkage connected to horizontal cross members 42 and 44 via sliders 46 a, b, c, d plus small control link(s) 48, 50 to keep the horizontal cross member(s) 42, 44 on center to the scissor linkage. The vertical center line 45 is shown by dotted line 45¹-45¹. This design has distinct advantages when used to adjust the height of a horizontal work surface. It collapses into a small envelope; the synchronized movement is accomplished with minimal parts to save money; and the maximum extension is only limited by width of cross bars or top and length of scissor links.

When the scissor linkace is designed as described below the scissor links 52 and 54 keep the upper and lower horizontal bars 42 and 44 parallel to each other because the scissor linkage creates two identical and opposing isosceles triangles aXb and AXB) which by definition always have 2 equal sides and two equal angles.

When the small control links 48 and 50 are added, it keeps the horizontal bars 42 and 44 centered to the scissor linkage 52, 54 because it creates identical isosceles triangles aCc and ADd that are proportional to aXb and AxB respectively. The small control links 48, 50 are connected at the center of the horizontal bars 42 and 44 which keeps the bars centered to the scissor linkage.

The pivot point and slider relationships are as follows:
Pivot points B, d, A and the two lower horizontal bar sliders 46c and 46d must be on same horizontal linear line.
Pivot points a, C, X, D, A are on the same linear line
Pivot points B, X, h are on the same linear line
Pivot points a, c, b and the two upper horizontal bar sliders 46a and 46b must be on same linear line.
Sliders 46 can be a device that rides in slots 47 in the horizontal bars 42 and 44 such as a pin or roller or a separate part that wraps around the bar in a way that attaches the slider 46 to the bar but gives free horizontal sliding movement. Sliders 46 are also designed to allow scissor links (aA & bB) to connect and pivot about the Slider's center.
Scissor links 52 and 54 (aA and Bb) are identical in length and each has a center pivot point X and a pivot point at each end equal distance from the center pivot (A, a, B, b).
One scissor link Aa 54 has two additional pivot points (C & D) that are located at the midpoint between pivot points aX and AX. These pivot points attach to the small Control Link 48 and 50.
The scissor linkage relationships are: Aa=Bb, AX=½Aa, BX=½Bb, AX=aX=BX=bX, aC=½aX, AD=½AX, aC=AD=CX=DX
The small Control Link cC and dD relationships are cC=AD, cC=¼aA=½aX=aC
Pivot points c and d are located at the center of the upper and lower horizontal bars respectively.

The simplest and least expensive height adjustable design is the table embodiment 60 as shown in FIGS. 6 and 7 is using a scissor linkage centered to a top. This can be accomplished by adding one control link Cc 62 to the scissor linage aA and hR designed to the geometric relationships described previously. This geometry synchronizes the movement so the top surface is always parallel to the floor. The part of the scissor linkage resting on the floor could have wheels or casters not shown) to facilitate movement.

This geometry creates a low cost adjustable height table, but there are two limitations; first the leg design makes the table look like an ironing board and second; the design does not easily attach to office panels or walls.

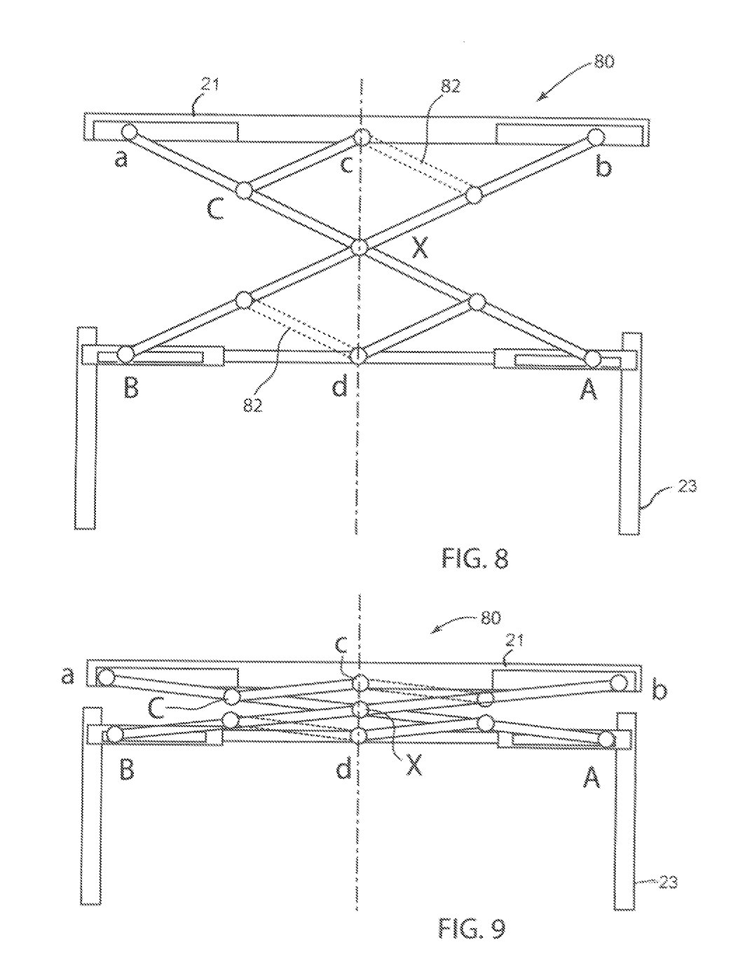

An alternate table leg design 80 is shown in FIGS. 8 and 9. As mentioned previously, the standard ergonomic height adjustment range for as table is between 27″ and 47″ for a 20″ adjustment range. Therefore, a 27″ height stationary leg of any design fulfills the need for a work surface at a height of 27″.

When the adjustment linkage is attached between the top and legs it can allow the work surface to rise to the 47″ height and keep the legs and top movements synchronized to each other.

Duplicate small control links 82 can be installed as shown in FIG. 8 in phantom. These extra control links do not improve keeping the table symmetrical about its center, but could help distribute and equalize forces to all the links resulting from heavy loads placed on the top.

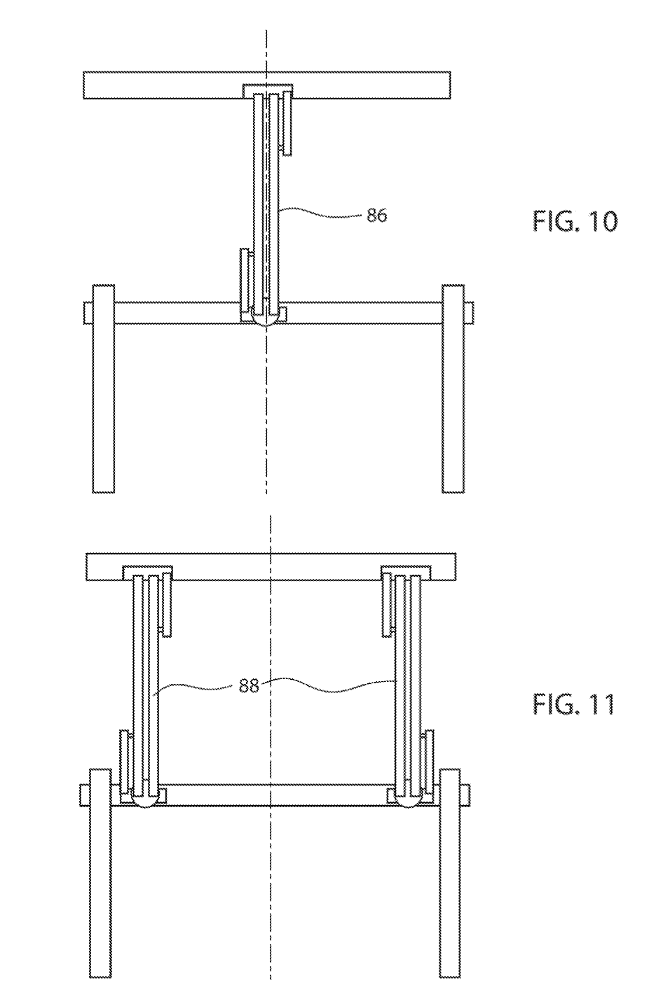

The end view shown in FIGS. 10 and 11 shows two table designs, a single scissor linkage 86 as shown in FIG. 10 and a two scissor linkages 88 as seen in FIG. 11 for improved stability and strength.

This design achieves the goal of attaching different leg designs but the following issues need to he considered from an engineering standpoint:
Can the single scissor design (FIG. 10) be engineered strong enough to withstand cantilevered loads and not wobble when used?
Will the cost of a two leg design (FIG. 11) exceed current telescoping tube designs?
Can the design be easily attached to an office panel or wall.

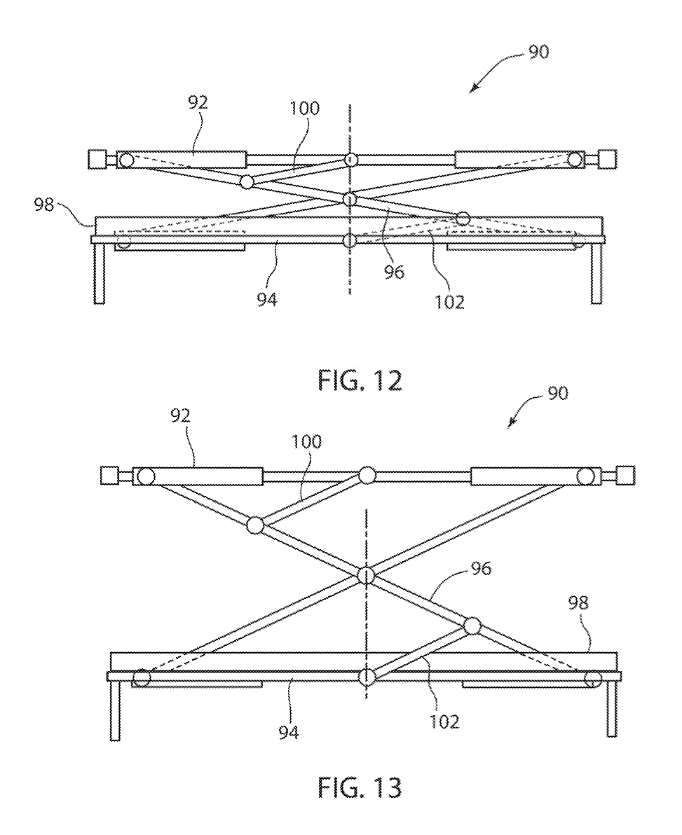

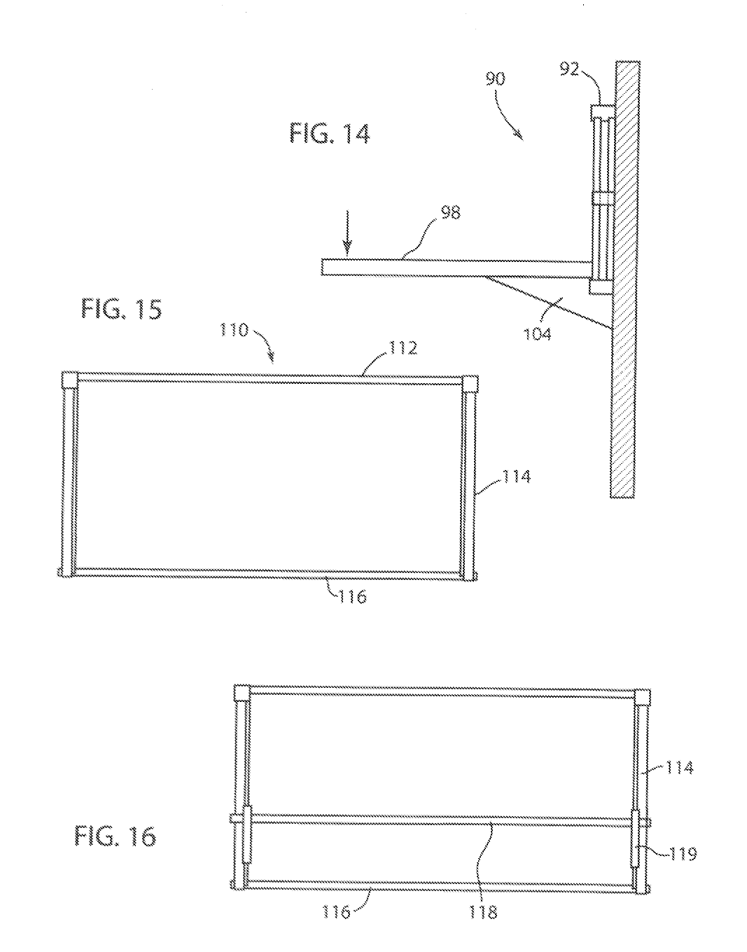

The wall mounted embodiment 90 as shown in FIGS. 12 through 14 is identical to the previous scissor linkage except the top horizontal linkage 92 is rigidly attached to a wall. The lower horizontal linkage 94 has two protruding support brackets at each end and is free to move up and down while suspended from the scissor linkage 96. The scissor linkage connects the two horizontal links 92 and 94 and the bottom horizontal link 94 and slides up and down the wall as the scissor moves. The work surface 98 rests on and is attached to the lower horizontal protruding support brackets. The two control links 100 and 102 keep everything centered and the sliders allow the scissors to open and close. Wheels or pads are attached at the back of the lower horizontal protruding brackets 104 to prevent wall damage during movement.

On the previous table leg design the linkage parts are in compression from loads placed on the work surface. On the wall mounted design all linkage parts are in tension and the wall provides vertical support for the mechanism. These structural advantages are later described in detail. Also attaching a work surface directly to a wall or office panel does not require legs for support, which is a cost savings.

An alternate improved wall mounted embodiment eliminates any marks on or damage to the wall.

A rigid frame 110 as shown in FIG. 15 made with one top horizontal rail 112 that that is designed to accept sliders for the scissors linkage; two vertical “U” channels 114 designed to retain and guide wheels attached to work surface supports; and a bottom horizontal rail 116 that completes the rigid frame and is not connected to the scissor linkage.

A horizontal work surface rail 118 shown in FIG. 16 has two protruding supports 119 attached to its ends and each support has two rollers or wheels which ride up and down in the two vertical channels of the rigid frame. The horizontal work surface rail is designed to accept the lower scissor linkage sliders and links.

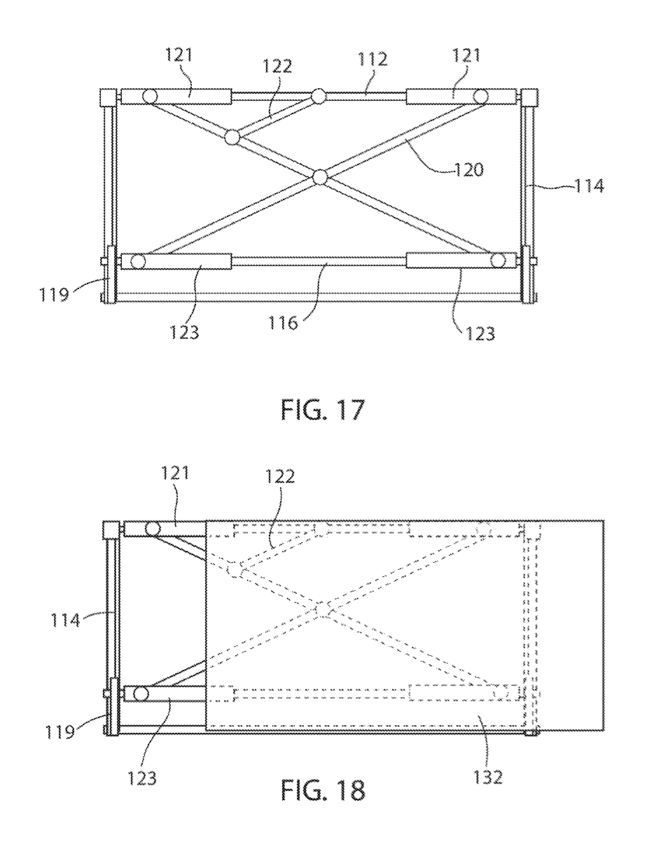

As shown in FIG. 17, the scissor linkage 120 is attached to the top horizontal rail 112 with two sliders 121 and a single small control link 122 and to the lower horizontal work surface rail 116 with two sliders 123, A work surface attached to the horizontal work surface rail stays centered because it rides between the two rigid frame vertical channels, therefore no lower small control link is required.

A cover 130 as shown in FIG. 18 can be attached to the frame to improve appearance and safety concerns regarding pinch points by covering the scissor linkage. The protruding supports 119 on the horizontal work surflice rail move in the space between the vertical channels and cover.

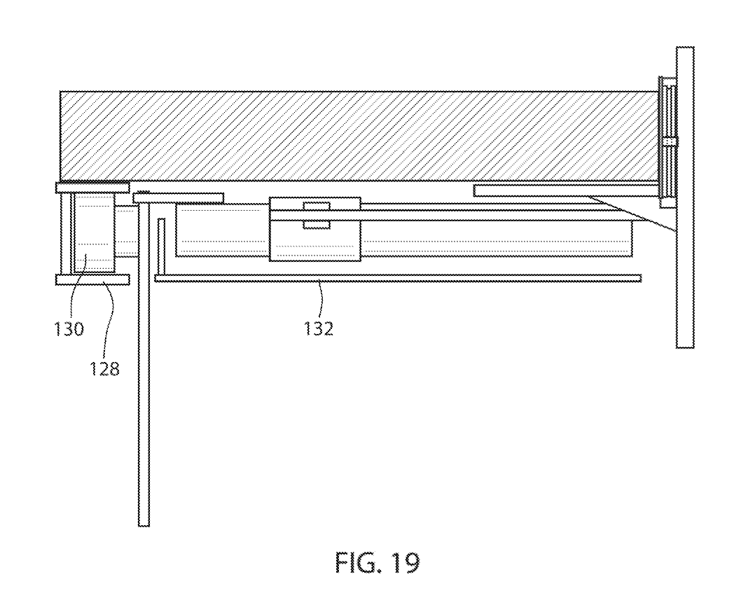

FIG. 19 is a top cross-sectional view looking down at horizontal work surface rail. The wheels 130, connected to the protruding part of the horizontal work surface rail ride in the vertical channel 128 and show the protruding supports extend out to accept the work surface 140. The rail moves vertically between the vertical channel 128 and the cover 130. Cover 132 covers the sliders, pivots and scissor links.

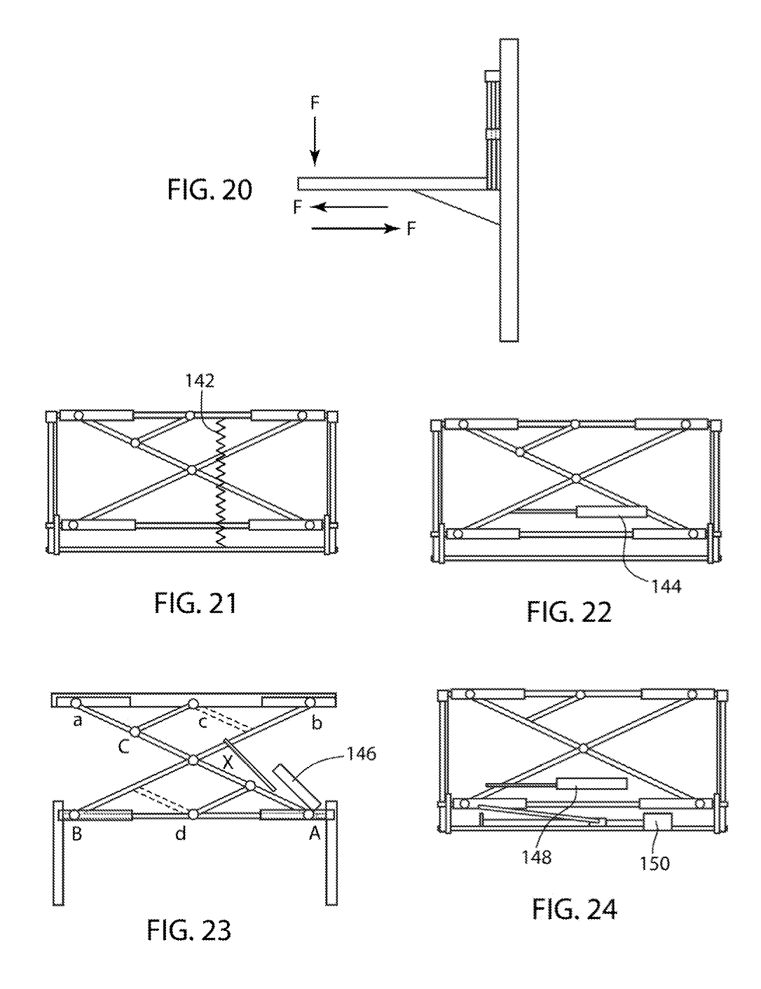

As shown by FIG. 20, forces F created by the weight of the cantilevered work surface plus any working load are directly transferred to the structural wall via a force couple (opposing tbrces) on the work surface bracket. The wail is a rigid structure and the vertical channels containing the work surface support wheels are secured to the wall. Therefore, the design is structurally strong and stable.

Both wall mounted designs offer work surface adjustment with the following features:
Low cost because of minimal parts
Work surface is strong and stable
Can attach to any wall or office and
No safety issues because mechanism is covered

The ideal surface with adjustable height would require minimal force for the user to lift the surface to a new position. This can be accomplished by using mechanical springs (compression or tension), gas springs or even electric motors to lift the weight of the work surface plus any working load. Also a spring and electric motor combination can be used. When the combination motor/spring design is used the spring would lift most of the weight, which reduces the electric motor size to save cost. The illustrations shown in FIGS. 21 through 24 are a few examples of spring and motor applications which could work on any of the embodiments previously described.

In the wall mounted embodiment shown in FIG. 21, extension spring 142 connected to the stationary top rail will exert a force to pull the work surface up. In the wall mounted embodiment shown in FIG. 22, a gas spring 144 positioned between two links exerts an upward farce on the work surface. In the freestanding table embodiment shown in FIG. 23, a gas spring 146 positioned between the lower horizontal and a scissor link exerts a force to lift the work surface. In the wall mounted embodiment shown in FIG. 24, a combination gas spring 148 to counter balance the load and an electric motor 150 is shown. As a threaded rod on the motor turns, a threaded nut moves horizontally which in turn moves a link that pushes the slider which lifts with surface.

As the work surface height is adjusted a brake is needed to hold the surface at the desired position. The following are three brake embodiments that can be used with the invention,

1. Electric Motor—The electric motor and threaded shall rod is a natural brake. The nut on the threaded rod is attached to the link, which activates the linkage. The nut can only move when the motor turns the threaded shaft. The threads are designed to prevent back drive from the load, so the work surface can only move when the motor is activated by a switch located on the work surface or cover. See FIG. 24.

2. Gas Spring—A optional feature for a gas spring is an internal valve that functions as a brake by stopping the piston movement in any position. The linkage cannot move if the gas spring is frozen in position. The valve can be activated by a cable attached to a hand-paddle type device located at the front of the work surface. When the hand-paddle is squeezed, the cable opens the gas spring, release valve, which allows the work surface to freely move. See FIGS. 22 and 23.

3. Manual Brake—A manual brake works well when the work surface load is counter balanced by a compression or extension spring. There are countless manual brake designs ranging from simple pin-in-a-hole designs to brake pad designs. The mechanical brake can be located at any point that prevents the linkage from moving and activated by a cable attached to a hand-paddle attached to the work surface.

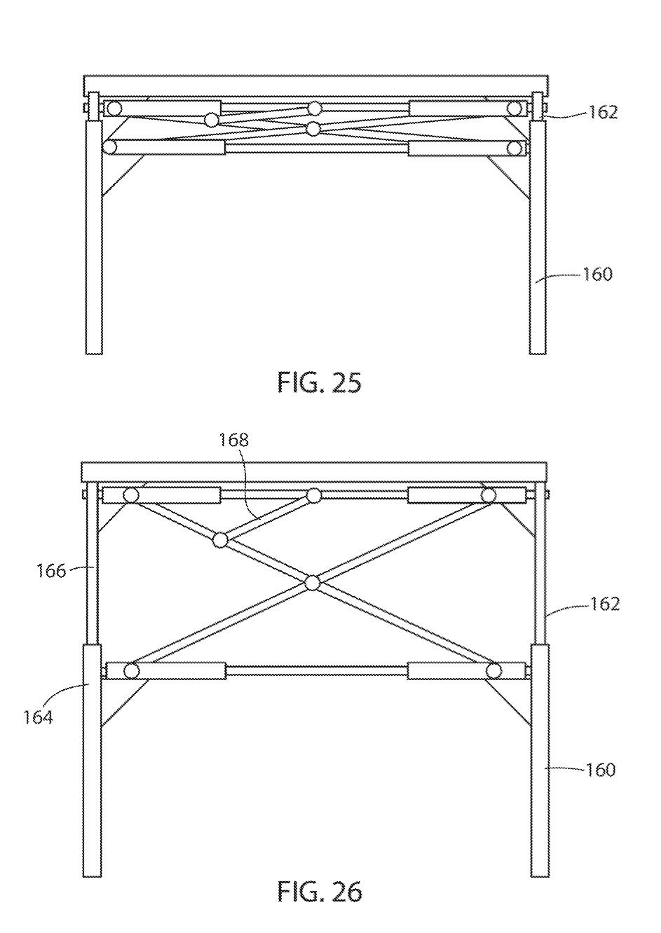

An optional wall attached linkage design discussed above can also be used on a freestanding adjustable table using telescoping tubes, as shown in FIGS. 25 and 26. The lower legs and horizontal bar 160 are a rigid structure and the horizontal bar is designed to accept the scissor linkage sliders. The tubes 162 and upper horizontal bar are a rigid structure and attach to the top work surface. The upper horizontal bar is also designed for the scissor sliders. The two rigid frames 164 and 166 as better shown in FIG. 26 can telescope inside each other without binding if perfectly square. However, the short control link 168 in the scissor linkage helps keep the motion of the right and left hand legs synchronized. This design is an alternative method to control the extension of telescoping tubes.

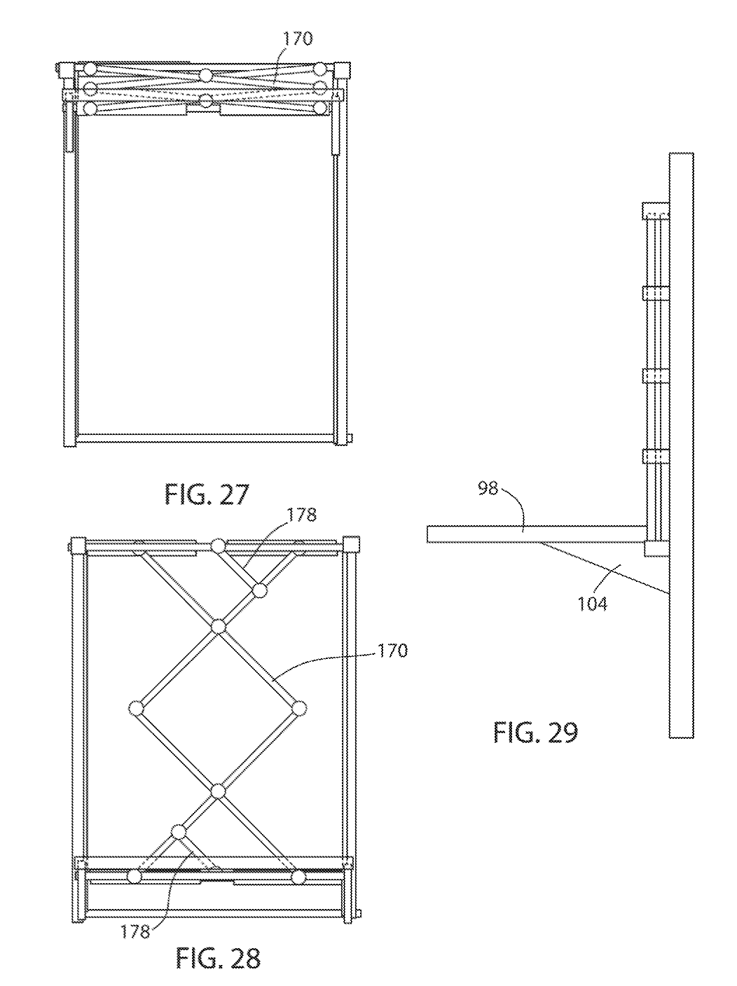

There are applications where the work surface height adjustment distance exceeds the device width, For example, the total device width is 18″, but 20″ of height adjustment is required. The solution is to add another scissor linkage 170 with two control links 178 as shown. This doubles the height adjustment potential and keeps the mechanism level and synchronized. See embodiment shown in FIGS. 27 through 29.

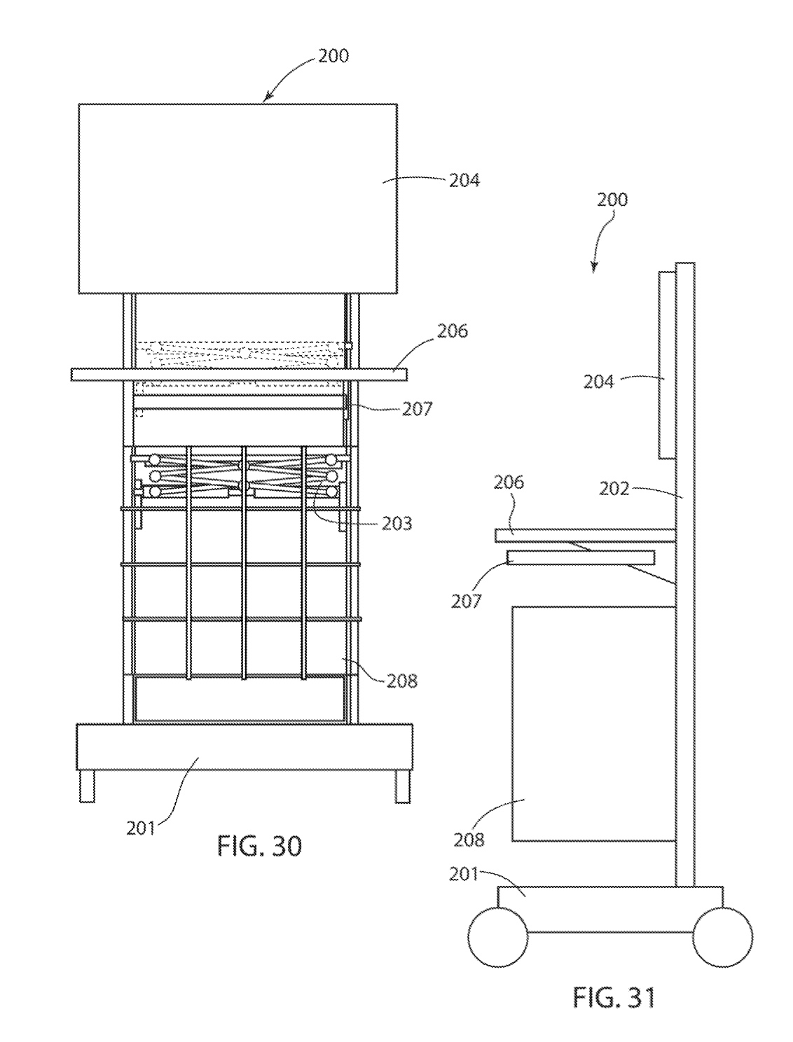

Another mobile embodiment is the medical cart 200 shown in FIGS. 30 and 31. The vertical channels could be free-standing with the bottom attached to a wheeled base 201. This creates a multifunctional vertical spine 202 to which several scissor mechanisms 203 can be attached for independent, attachment and adjustment. For example, the vertical spine 202 could have a monitor 204 in a fixed position at the top, an adjustable writing surface 206, a pull-out keyboard surface 207 or even storage bins 208.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What I claim is:

1. A work surface height adjustment apparatus comprising a work surface platform, an expandable scissors assembly mounted to said platform, said scissors assembly comprising a horizontal cross member, a scissors linkage slidably mounted to said horizontal cross member by slide means and an interconnected linkage comprising slide links mounted to said slide means and a center link pivotally mounted to distal end of each slide link, said scissors linkage when extended synchronizing the scissors movement to the top surface of the work member creating two identical and opposing triangles in said scissors linkage.

2. A work surface height adjustment apparatus as claimed in claim 1 wherein said scissors linkage includes a plurality of slidable members mounted on said horizontal cross member, a push link pivotally mounted a slidable member, a pull link mounted to another said slidable member and a center link pivotally mounted to the ends of said push and pull links.

3. A work surface height adjustment apparatus as claimed in claim 1 wherein said scissors linkage comprises two equal length members pivotally mounted together at the center point of each member.

4. A work surface height adjustment apparatus as claimed in claim 2 wherein the end of said scissors linkage has pin means which is slidable mounted in a slot means defined in said horizontal cross member.

5. A work surface height adjustment apparatus as claimed in claim 4 wherein the end of said scissors linkage has sleeve means which is slidable mounted on said horizontal cross member.

6. A work surface height adjustment apparatus as claimed in claim 1 wherein said legs are mounted on opposite ends of said horizontal cross member.

7. A work surface height adjustment apparatus comprising a work surface platform, an expandable scissors assembly mounted to said platform, said scissors assembly comprising a horizontal cross member, a scissors links slidably mounted to said horizontal cross member by slide means, said scissor linkage comprising two link members pivotally mounted together at their center point and at least one control link pivotally mounted to the center of said horizontal cross member and pivotally mounted to a scissors link member, said scissors linkage when extended synchronizing the scissors movement to the top surface of the work member creating two identical and opposing triangles.

8. A work surface height adjustment apparatus as claimed in claim 7 wherein said work surface platform is a table.

9. A work surface height adjustment apparatus as claimed in claim 7 Wherein said work sUrface platform sall mounted.

10. A work surface height adjustment apparatus as claimed in claim 7 including an energy supply apparatus mounted to said table adapted to provide lift to the work surface.

11. A work surface height adjustment apparatus as claimed in claim 10 wherein said energy supply apparatus is a spring.

12. A work surface height adjustment apparatus as claimed in claim 10 wherein said energy supply apparatus is a gas spring.

13. A work surface height adjustment apparatus as claimed in claim 10 wherein said energy supply apparatus is an electric motor.

14. A work surface height adjustment apparatus as claimed in claim 7 wherein said scissors assembly is a plurality of connected scissors assemblies.

15. A work surface height adjustment apparatus comprising a frame with side standards defining vertical channels, an expandable scissors assembly moveably mounted to said standard said scissors assembly comprising a horizontal cross member, a plurality of scissors link members slidably mounted to said horizontal cross member, said scissor link members being pivotally mourned together at their center point and at least one control link pivotally mounted to the center of said horizontal cross member and pivotally mounted to a scissors link member, said scissors linkage when extended synchronizing the scissors movement to the top surface of a work member.

16. A work surface height adjustment apparatus as claimed in claim 15 wherein said scissors assembly comprises a plurality of stacked scissors assemblies.

17. A work surface height adjustment apparatus as claimed in claim 15 wherein motor means for expanding said scissors assenibly is mourned to said frame.

18. A work surface height adjustment apparatus as claimed in claim 15 wherein said frame is wall mounted.

19. A work surface height adjustment apparatus as claimed in claim 15 wherein said frame is mounted in a cart.

20. A work surface height adjustment apparatus as claimed in claim 15 wherein said frame has legs which are telescopic.
